(19) United States
(12) Patent Application Publication
(10) Pub. No.: US 2014/0263039 A1
(43) Pub. Date: Sep. 18, 2014

(54) METHOD AND APPARATUS FOR UNICELLULAR BIOMASS PRODUCTION USING pH CONTROL SYSTEM AND INDUSTRIAL WASTEWATER WITH HIGH BIOCHEMICAL OXYGEN DEMAND LEVELS

(71) Applicant: Algal Scientific Corporation, Plymouth, MI (US)

(72) Inventors: Geoffrey P. Horst, Grosse Pointe Farms, MI (US); Robert B. Levine, Ann Arbor, MI (US); Jeffrey R. LeBrun, Ann Arbor, MI (US); James Bleyer, Maumee, OH (US)

(21) Appl. No.: 14/211,100

(22) Filed: Mar. 14, 2014

Related U.S. Application Data
(60) Provisional application No. 61/800,617, filed on Mar. 15, 2013.

(51) Int. Cl. C02F 3/28; C02F 3/30; C02F 3/32

(52) U.S. Cl. CPC C02F 3/28; C02F 3/322; C02F 3/30
USPC 210/602; 210/601; 210/605; 210/610

(57) ABSTRACT

Methods and systems for the growth of heterotrophic eukaryotic biomass that use pH modulations in order to treat wastewater and produce biomass in optimized quantities.

### CROSS-REFERENCE TO RELATED APPLICATIONS

This application claims the benefit of U.S. Provisional Application No. 61/800,617, filed on Mar. 15, 2013. The entire disclosure of the above application is incorporated herein by reference.

### FIELD

The present technology relates to wastewater treatment where the pH is purposely modulated upwards or downwards to create a physiological stressor that reduce the prevalence of prokaryotic microbes and allows eukaryotic microbes to survive.

### INTRODUCTION

This section provides background information related to the present disclosure which is not necessarily prior art.

Biologically-driven methods and systems for wastewater treatment typically utilize heterotrophic prokaryotes, such as bacteria, that optimally grow in a medium having a pH in the range of 6.5 to 7.5. Acid or base can be added in order to reduce or increase the pH as necessary to maintain the pH within the optimal range. However, in maintaining the pH, a target value or range is typically held constant to reduce pH fluctuations that can kill or otherwise harm the microbial community used for treating the wastewater.

Another problem wastewater treatment faces is that current treatment methods and systems, such as activated sludge systems, are not very effective in removing certain nutrients such as nitrogen and phosphorus. Bacteria-based systems are good at reducing biological oxygen demand (BOD), but the downside is that the bacteria are typically not able to effectively sequester nitrogen and phosphorus to target levels. Recent strategies to improve nutrient removal include the use of additional processes to: (a) remove nitrogen via nitrification and denitrification steps; and (b) remove phosphorus via chemical/biological precipitation. These additional processes increase capital requirements and, perhaps more importantly, require expensive and sometimes dangerous chemical inputs such as methanol to remove the nutrients from the waste stream.

### SUMMARY

The present technology includes systems, processes, apparatus, articles of manufacture, and compositions that relate to treating wastewater by cycling the pH of the growth media to favor persistence or viability of desired eukaryotic microorganisms and disfavor persistence or viability of undesired prokaryotic microorganisms. For example, the wastewater treatment process can be employed using a system designed to modulate the pH of a reactor upwards and/or downwards by at least 1 pH unit at a given frequency. Modulating the pH in this fashion creates a physiological stressor that helps to reduce the prevalence of prokaryotes and allows eukaryotes to survive.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1. Process flow diagram showing a pH controlled bioreactor according to the present technology, where dotted line flow paths indicated optional processes, including seed inocula system, nutrient addition system, anaerobic digestion process, harvesting system, drying system, metal complexing system, and light sources for either the seed inocula tank and/or main bioreactor.

FIG. 2. Process flow diagram of an embodiment of a sequencing batch reactor configuration.

FIG. 3. Process flow diagram of an embodiment of a membrane apparatus for separation of the algae from a wastewater growth tank where, for example, the apparatus can be used in an SBR configuration. Some biomass is removed and used to seed the other tank, where algae can be selected based upon health and age for seeding of the growth chamber.

FIG. 4. Process flow diagram of a technique for selecting healthy and desirable microorganism from non-healthy or undesirable microorganism when the strain of algae that is selected is both motile and can be attracted to light.

FIG. 5. Another algae separation technique is shown where a light source is used to repel the desirable microorganism, such that it may be separated from the undesirable microorganisms for reseeding of the growth chamber and cultivation of a desired population of microorganisms.

FIG. 6. A sequencing batch reactor (SBR) configuration is shown that controls pH and uses heterotrophic algae in order to reduce the biochemical oxygen demand of the wastewater while also producing algae biomass

FIG. 7. A configuration for production of biomass using heterotrophic algae on industrial wastewater in a process that is conFIG.d for low-pH.

FIG. 8. A process flow diagram for production of algae biomass using a low-pH biomass chamber. In this configuration, the CO2 source is the combustion of biogas that is produced onsite and there is an additional anaerobic digestion pretreatment step.

FIG. 9. A process flow diagram showing a detailed configuration for a treatment system with separate seed tanks that are intended to propagate the target microorganism before adding them to the main treatment tanks. A filter press is show to illustrate an example harvesting process for removing the treatment microorganisms and reducing the amount of solids in the treatment effluent.

FIG. 10. Results of four bench-scale experiments (T1, T2, T3, and T4) demonstrating the BOD removal efficiency of a low-pH biological treatment process. An inoculum of Euglena and other heterotrophic protists/algae (5 or 15 ml) was added to 95 or 85 ml (respectively) of untreated brewery wastewater. The pH was lowered to 5 and samples were taken every 24 hrs. BOD analysis was performed on the supernatant of centrifuged samples using standard methods.

FIG. 11. Results of four bench-scale experiments (T1, T2, T3, and T4) demonstrating the COD removal efficiency of a low-pH biological treatment process. An inoculum of Euglena and other heterotrophic protists/algae (5 or 15 ml) was added to 95 or 85 ml (respectively) of untreated brewery wastewater. The pH was lowered to 5 and samples were taken every 24 hrs. Chemical oxygen demand (COD) analysis was performed on the supernatant of centrifuged samples using HACH brand COD analysis tubes and protocols.

FIG. 12. Results of four bench-scale experiments (T1, T2, T3, and T4) demonstrating the total nitrogen removal efficiency of a low-pH biological treatment process. An inoculum of Euglena and other heterotrophic protists/algae (5 or 15 ml) was added to 95 or 85 ml (respectively) of untreated brewery wastewater. The pH was lowered to 5 and samples were taken every 24 hrs. Total nitrogen analysis was performed on the supernatant of centrifuged samples using HACH brand total nitrogen protocols.

FIG. 13. Data obtained from the four bench-scale experiments, showing chemical oxygen demand (COD), total nitrogen (TN), total suspended solids (TSS), and biological oxygen demand (BOD) at days 0, 1, 3, and 8 of the four cultures (T1, T2, T3, and T4).

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding the methods disclosed, the order of the steps presented is exemplary in nature, and thus, the order of the steps can be different in various embodiments. Except where otherwise expressly indicated, all numerical quantities in this description, including amounts of material or conditions of reaction and/or use are to be understood as modified by the word “about” in describing the broadest scope of the technology.

The present technology utilizes a heterotrophic eukaryote in a wastewater treatment process that is combined with a system designed to modulate the pH of a reactor upwards and/or downwards by over one whole pH unit (i.e., a 10-fold change in hydrogen ion concentration), where the pH modulation can occur at a given frequency. The pH is modulated either upwards or downwards in order to create a physiological stressor that helps to reduce the prevalence of prokaryotes and allows eukaryotes to survive.

The present technology can achieve a substantial reduction of biochemical oxygen demand (BOD) (e.g., about 95%), total phosphorus (P) (e.g., about 90%), and total nitrogen (N) (up to about 70%) using a 2-day residence time. However, by increasing the availability of algae-accessible BOD, N and P, the process can be further improved. In particular, embodiments of the present technology can include one or more of: (a) increasing the proportion of BOD as simple carbohydrates, alcohols and fatty acids, (b) increasing the proportion of the total phosphorus as phosphate (PO₄); and (c) increasing the proportion of total nitrogen as ammonium (NH₄). In order to increase the proportion of algae-accessible BOD, P, and N and provide a natural mechanism of pH control, acidic pre-fermentation of high strength industrial wastewaters is employed. This process improves removal of N while producing an additional useful byproduct: hydrogen gas.

Acidic pre-fermentation can be the first stage in an anaerobic process called anaerobic digestion. Anaerobic digestion begins with the disintegration and hydrolysis of particulate organic matter. Organic polymers, such as polysaccharides, proteins, and lipids, are hydrolyzed into simple soluble compounds that can be absorbed by bacterial cells. Next, fermentative bacteria convert these monomers into low-molecular-weight organic acids (i.e. volatile fatty acids) and alcohols, mainly acetate, propionate, butyrate, and ethanol. During this process of acetogenesis, some fermentation products are also oxidized to acetate and H₂ by hydrogen-producing acetogenic bacteria or converted into CO₂. Methanogens then convert acetate and H₂ into CH₄ and CO₂ (i.e. biogas).

Anaerobic digestion is typically practiced at waste water treatment plants where bacterial sludges are dewatered from about 1-2% solids to 5-6% solids and then digested for 15-30 days, yielding a biogas that is a mixture of methane (about 60%) and carbon dioxide (about 35%). Anaerobic digestion is also employed to at industrial facilities producing high-strength wastewater (i.e. BOD>3000 mg/L). In both situations, complete anaerobic digestion of the waste stream results in BOD removal by converting carbon in soluble compounds into gaseous forms. While useful in this respect, anaerobic digestion does not remove soluble N and P and actually increases the concentration of these nutrients in the effluent. In addition, long solids retention times are required to sustain methanogenic bacteria, which are slow growing, and digesters are notoriously sensitive to rapid changes in feedstock loading and composition.

Acidogenesis and methanogenesis have distinct, and in many ways, incompatible optimal conditions. For example, methanogensis is highly sensitive to low pH, and excessive volatile fatty acid production during acidogensis can severely limit methane production. The ideal pH range for hydrolysis and acetogenesis has been reported to be pH 5.0 to 6.5, whereas methanogenesis occurs optimally around pH 7.0. Instead of attempting BOD removal through complete anaerobic digestion, acidogenesis is employed to convert BOD into volatile fatty acids and acidify the high-strength industrial wastewater that is to be treated. Various operational parameters of the acidogenic process (e.g. reactor configuration, hydraulic retention time, and solid retention time) can be tailored to produce a wastewater most amenable to nutrient removal in an aerobic bioreactor. In this way, costs associated with treatment by reducing the process hydraulic retention time and improving nutrient removal efficiency are minimized.

While one focus is on nutrient removal from the wastewater, a goal of the acidic pre-fermentation process, to produce volatile fatty acids under acidic conditions and limit methanogenesis, is similar to dark fermentation of organic wastes for biohydrogen production. In this regard, H₂ is a major byproduct of some fermentative reactions and can be recovered from reactors as a valuable fuel. To limit methanogenesis, reactors can be run at short hydraulic retention times and under acidic conditions. In addition, sludge used to inoculate such reactors, which is commonly obtained from anaerobic digesters at waste water treatment plants, can be pre-treated (e.g. acid-base, thermal) to remove methanogens and select for hydrogen-producing bacteria (e.g. Clostridium) that survive these treatments (by forming endospores). Although large-scale biohydrogen production from industrial wastes has not been demonstrated, significant pilot scale studies have indicated that this is a promising route to produce H₂ fuel. Moreover, it is recognized that biohydrogen production results in less than 10% chemical oxygen demand (COD; a proxy for BOD) removal, thereby necessitating some kind of downstream wastewater treatment process. Biohydrogen production therefore can be integrated into the present technology, where H₂ can be captured to produce enough electricity, for example, to run a portion or all of the wastewater treatment process, much like biogas from complete anaerobic digestion can be combusted to power an activated sludge facility.

Activated sludge is the biological process that is used to treat BOD in virtually every biological wastewater treatment plant in the world. Activated sludge is largely composed of saprotrophic bacteria but also contains protozoa such as amoebae, Spirotrichs, Peritrichs and rotifers. However, the actual reaction rates of BOD, total kjeldahl nitrogen (TKN) and total phosphate (TP) are also strongly influenced by temperature, pH, substrate, and oxygen levels. The enzymes which regulate many of the biochemical reaction in bacteria are very pH dependent. The optimum pH is between 7.0 and 7.5 for the proper activated sludge microorganisms to dominate in current state-of-the art bacteria wastewater treatment systems. These systems tend to crash or to achieve suboptimal results when the pH exits this range.

Unlike a bacteria-based process, a eukaryote-based process can actually sequester nutrients into the biomass as the eukaryotes grow, with very little being recycled back into the water. As a result, when eukaryotic cells are harvested out of the water, nearly all of the nitrogen and phosphorus is tied up in the eukaryotic biomass and the water can be discharged with minimal additional processing. One advantage of such systems is that they can cost less to operate than other methods for treating certain types of wastewater by eliminating the need to have several different steps to remove BOD, nitrogen, and phosphorus and the subsequent expensive and potentially dangerous chemical inputs needed in each of these steps. In addition, at low ranges of pH, below 6 or 7, nitrification and denitrification pathways are inhibited, where such prokaryotic-based wastewater treatments employ an optimal pH that is close to neutral, in the range of 6 to 8, whether the process is activated sludge, nitrification/denitrification, or anaerobic digestion.

Bulk water pH value is an important factor in nitrification activity for two reasons. First, a reduction of total alkalinity may accompany nitrification because a significant amount of bicarbonate is consumed in the conversion of ammonia to nitrite. While reduction in alkalinity does not impose a direct public health impact, reductions in alkalinity can cause reductions in buffering capacity, which can impact pH stability and corrosivity of the water toward lead and copper. Relationships between pH, alkalinity, corrosivity, and metals leaching can therefore present certain issues. Second, nitrifying bacteria are very sensitive to pH. Nitrosomonas, for example, has an optimal pH between approximately 7.0 and 8.0, and the optimum pH range for Nitrobacter is approximately 7.5 to 8.0. Some waste water treatment methods show that an increase in pH (to greater than 9) can be used to reduce the occurrence of nitrification. However, many other factors contribute to the viability of nitrifying bacteria, and as a result, nitrification episodes have been observed at pH levels ranging from 6.6 to 9.7. Therefore, in prokaryotic-based systems, a pH between 7.0 and 9 is typically used for removal of nitrogen as N₂ gas. In some systems where a tertiary treatment step is required for the removal of nitrogen, the system is kept at a pH of 7.0 to 9. For example, denitrification can occur faster within this optimal pH range while barely occurring at all at a pH of 5. For this reason, much effort has been designed to measure and model the optimal pH of wastewater treatment systems. Systems based upon programmable logic controllers have been designed that optimize the pH of this system to remain almost constantly in a range of 7.0 to 9 in these systems.

Ammonia (NH₃) is toxic to many microorganisms and some wastewater includes high amounts of ammonia at such toxic levels. Ammonium ion (NH₄⁺) is less toxic to most microorganisms and in some cases is the preferred form of nitrogen for uptake into cells for microorganism growth. Ammonia and ammonium ion are interchangeable depending on pH. At higher pH, most of the ammonia/ammonium is in the ammonia form. At lower pH, most of the ammonia/ammonium is in the less toxic ammonium ion form. For example, at a pH of 7.5 and 25 degrees C., only about 1% of the ammonia/ammonium is in the ammonia form and therefore ammonia toxicity may be reduced.

The present technology accordingly provides methods and systems that employ a bioreactor that receives a flow of wastewater influent, discharges a flow of effluent representing approximately the same volume as the influent, includes a community of microorganisms populating the bioreactor, an aeration or oxygenation system used to provide oxygen for the aerobic heterotrophic microorganisms, and a system to increase and/or decrease the pH of the bioreactor. As one example of wastewater treatment, a wastewater influent from a food processor can have a BOD level of 2000 mg/L at a flow rate of 1 million gallons per day. The bioreactor tank can have a volume of 2 million gallons, giving a hydraulic retention time of 2 days. An aeration system can nominally keep oxygen levels on average above 1.0 mg/L using standard equipment and processes, such as a blower system with fine bubble diffusers placed at the bottom of the reactor. The reactor can be made of any material and nearly any dimension, with a preference for tanks that are at least 2 meters deep in order to increase oxygen transfer efficiency from one or more bubble diffusers. The pH control system can be a pH probe attached to a meter, pH controller, programmable logic controller or similar device that can monitor pH levels and has the capacity for turning on acid or base addition systems. Microorganisms in the bioreactor can be inoculated from a population of a single type of microorganism or a community of many different types of microorganisms. The microorganisms can be self sustaining in the bioreactor without further additions of inocula as long as the doubling time of the microorganisms are faster than the hydraulic retention time of the reactor. For example, if the desired microorganism(s) have a doubling time of 24 hours and the hydraulic retention time in this example is 60 hours, then the microorganisms will grow fast enough to keep a sustainable population density in the reactor. In the most basic design, the effluent from the bioreactor is simply a mixture of the microorganisms and solution from the bioreactor. Ideally, for a wastewater influent containing 2000 mg BOD/L, and a hydraulic retention time of 2.5 days, the concentration of microorganisms in the bioreactor at any given instant can be over 700 mg/L and the residual BOD concentrations after removing the microorganisms can be less than 500 mg/L and preferably less than 250 mg/L.

The operation of the pH control system can be modified to optimize either treatment performance, target microorganism growth or both. In the above example, with a wastewater influent composition of 2000 mg BOD/L from a food processor, the incoming pH level could be around 7.5, which would be close to ideal for prokaryote (e.g., bacteria) growth. Under normal steady-state conditions without pH control, the pH of the bioreactor will be a function of the pH of the wastewater effluent and the combined effects of both biological and inorganic processes in the bioreactors that may increase or decrease the pH. For example, normal respiration of organic carbon by heterotrophic microorganisms typically reduces pH because carbon dioxide from respiration produces carbonic acid. In the present technology, the pH of the bioreactor is purposely modulated by adding acid or base through a pH control system.

Increasing or decreasing pH in the system alters the enzymatic reaction kinetics, which can lead to altered selection and growth rates of microorganisms in the reactor. The target microorganisms in this system are those that are adapted and/or acclimated to highly variable pH conditions and/or those acclimated or adapted to very high or low pH (i.e. above 9 or below 6). Typically, prokaryotic cells (e.g., bacteria) are less able to survive such pH fluctuations and growth of the prokaryotes can be substantially reduced. By contrast, eukaryotes are typically more able to tolerate these pH fluctuations, which can lead to a sustained community of microorganisms that can include eukaryotic flagellates, ciliates, protozoa, and in particular some species of algae. Certain heterotrophic algae species have an optimal growth performance at a pH below 6, such as Euglena.

In the most basic design, rapid pH fluctuations either upwards or downwards of 1 unit or more (over the span of less than 4 hours) can typically inhibit the growth, if not kill, a proportion of the microbial community, with prokaryotes typically being more sensitive than eukaryotes. Evidence for this effect can be seen by rapid foam development in the wastewater media which is a symptom of proteins being released from lysed (killed) cells. Since eukaryotes tend to be less sensitive to pH fluctuations, this allows them to outcompete the prokaryotes. The frequency of the pH fluctuations can vary depending the flow rate of the wastewater influent, the residence time of liquid in the bioreactor(s), and the desired impact of the pH fluctuations on controlling the competitive balance between prokaryotes and eukaryotes in the bioreactor. Fluctuations in pH can be achieved using a pH controller integrated with a timer so that, for example, at 4 hour intervals the pH controller would activate either an acid or base delivery system (e.g., peristaltic pump drawing from an acid reservoir) and deactivate the delivery system after the pH has dropped or risen by the desired magnitude; e.g., 1 pH unit. More drastic impacts on the community can be achieved with a larger magnitude pH fluctuation; i.e. more than 1 pH unit. Fluctuations as large as 4 pH units can be used in certain embodiments so that nearly all but the most robust eukaryotic microorganisms are killed off.

In some cases, the normal metabolism of the reactions in the bioreactor can cause the pH to rise or fall. For example, if the incoming pH of the wastewater is pH 8 and effects of the microbial metabolism combined with any inorganic chemistry effects (i.e. offgasing) cause the pH to normally drop to pH 7, then the steady state pH level will tend to end up around pH 7. Therefore, rapid pH fluctuations back up to pH 8 can be effective in killing off sensitive prokaryotes, but over time the pH will trend back to pH 7 again the process can be repeated. If the pH does not naturally trend upwards or downwards, then pH fluctuations can be achieved by performing one interval where the pH is adjusted upward by 1 pH unit or more and then at the next interval (e.g., 4 hours), the pH can be dropped by 1 pH unit or more.

If the pH is decreased, the potential for ammonia toxicity is also reduced. The relative amounts of ammonia versus ammonium ion is regulated by the pH, with relatively higher proportion of ammonia at higher pH. By lowering the pH, especially below 7.5, most of the ammonia is converted into the less toxic ammonium ion.

In contrast to certain bacteria-based wastewater treatment system, the present heterotrophic eukaryote system generates more biomass than the activated sludge process as a greater percentage of molecular mass can be taken into the cell structure. For example, eukaryotic cells can accumulate more biomass in comparison to activated sludge or anaerobic digester bacterial communities. Evidence for this difference is seen in the biomass conversion efficiency. Typical prokaryote based systems have BOD:biomass (dry) conversion efficiencies of less than 20% (i.e. 1 mg BOD/L is converted into 0.20 mg dry biomass/L). Eukaryote-based systems can achieve greater than 35% BOD:biomass conversion efficiencies.

The present technology can be performed with several types of bioreactor systems. Examples of such systems include: continuous-flow reactors; sequencing batch reactors (SBR); moving bed reactors; gas-lift loop reactors; fluidized bed reactors; and membrane bio-reactors. Various aeration methods can likewise be employed, such as bubblers, mixing, spraying, and the use of shallow reactors that provide an increased surface area between the wastewater media and air.

For treating wastewater, the microorganisms growing in the bioreactor can be removed from the effluent stream using a wide variety of solid/liquid separation harvesting technologies. Examples include filtration, settling, dissolved air flotation, and suspended air flotation. Each of these separation technologies can also be used in combination with added chemicals to flocculate the microbial cells. By harvesting the microbial cells from the bioreactor effluent stream, the remaining liquid effluent will have lower BOD and/or lower nutrients.

The pH may also be adjusted to promote or inhibit target particles from absorbing to the eukaryotic cells, membranes, flocculent, or other molecular surfaces which are exposed in the bioreactor tank. For example, the alteration of pH may be used to promote binding of a target molecule, such as a polychlorinated biphenyl, to the heterotrophic algae or to a coagulant or flocculent that is added to the solution. Any addition of an acid to the wastewater solution may be used to lower the pH. Acids can include acetic acid, ascorbic acid, carbonic acid, hydrochloric acid, sulfuric acid, sulfamic acid, nitric acid, phosphoric acid, acids produced through a fermentation process, and any organic acid or any other acid.

Another method of reducing the pH of the wastewater/bioreactor solution for treatment with a low-pH process is to deliver carbon dioxide from the emissions of a nearby combustion process. In a preferred embodiment this carbon dioxide may be derived from the combustion of methane or biogas that is generated in an anaerobic digestion process. The anaerobic digestion may occur in an upstream or downstream anaerobic wastewater treatment step or on a nearby source of digesting organic matter, such as landfill waste or manure.

Any base can be used to increase the pH of the bioreactor solution. Bases include sodium hydroxide and potassium hydroxide. Ammonium hydroxide can also be used to increase pH and has the added benefit of adding nitrogen, which is an essential element for microorganism growth. Other chemicals that can neutralize acids, such as calcium carbonate, can be used to increase pH.

Although the present technology can work with any type of wastewater that needs treatment of biological oxygen demand, nitrogen, or phosphorus, the present systems and methods have proven effective in treating concentrated wastewater solutions. A solution that relies primarily upon bacterial growth in a pH range above 6.5 may not work, or it may lead to repeated system crashes and an unstable biological balance. Moreover, although other methods may teach the addition of acid to bring the wastewater pH down from basic solutions to a range of 7, only the present technology uses the addition of acid to intentionally reach levels below a pH of 7, where some embodiments include lowering the pH to one or more pH units below 7. Typical wastewater treatment by anaerobic digestion with bacteria, for example, does not reduce the pH below 7 as doing so has a negative impact on the performance of the heterotrophic bacteria.

In some embodiments, wastewater that is treated using the present technology can have BOD concentration level above 500 mg/L, total nitrogen level above 100 mg/L, and total phosphorus concentration above 5 mg/L. If these concentrations are not present, nitrogen or phosphorus can be added to the wastewater from a nitrogen or phosphorus containing compound to obtain the desired concentration. Additional essential nutrients, such as trace elements, can also be added in order to promote biomass growth.

Another benefit of maintaining lower levels of pH is to inhibit the bacterially-driving nitrification reaction from occurring. This reduces the oxygen demand of the system, therefore reducing the aeration needs and the potential energy costs. Additionally, if the algae are capable of photosynthesis and if they are receiving light, they can create additional oxygen for the system and reduce the carbon dioxide concentration.

In various embodiments, the low-pH biological reaction takes place in a sequencing batch reactor that includes two tanks with a common inlet that can be switched between them, and a common outlet. Each tank operates on the following cycle, with the cycles staggered such that there is consistent ability to receive influent. The cycle consists of filling the tank, aerating, settling the tank, and decanting the water from the tank. The biomass sludge may be removed completely or some sludge can be transported to the other chamber to seed the alternate bioreactor. Additional nutrients may be added to one or both tanks to supplement any elements that may be limiting the growth of the target eukaryote microorganism(s).

A seed population of the target eukaryotic microorganism(s) can be grown in a separate seed reactor in parallel to the main bioreactor treatment. In this case, the seed reactor tank can be operated with different environmental conditions than the main reactor tank in order to further favor the growth of the target microorganisms. In particular, the seed reactor tank can have a different pH control regime, different aeration regime, different exposures to light and/or different nutrient concentrations than the main bioreactor. For example, if the main reactor tank has a hydraulic retention time of 2.5 days, a seed tank may utilize a retention time of 5 days in order to allow the eukaryotic microorganisms more opportunity to outcompete prokaryotes. Similarly, if the target eukaryotic microorganism is capable of photosynthesis in addition to heterotrophic growth, then the seed tanks can be exposed to a sufficient level of natural or artificial light in order to help the microorganism grow partly under photosynthesis which will allow the microorganism a competitive advantage over strictly heterotrophic microorganisms. The seed tank can be filled with a slip stream of the main wastewater influent, which will allow the microorganism an opportunity to acclimate to the wastewater chemistry or the seed tank can be filled completely with a media specific to the growth of a target microorganism. For example, a monoculture of a target microorganism could be grown under sterile conditions either in a closed photobioreactor or in a sterile fermenter.

A system for selecting the species desired to be cultivated can also be placed between the tanks to provide a desirable seed floc. For example, if a heterotrophic algae is the desirable species then a membrane may be used to pump out the effluent, such that the pore size excludes the algae from passing through but does not exclude the bacteria. The remaining biomass will then consist of a greater percentage of the desirable algae than the bacteria prior to seeding the other tank. Unlike existing sequencing batch reactors that rely almost strictly upon settling, the aeration may be left on for a portion of the settling process. In certain embodiments, an antibiotic can be added to the seed biomass prior to transfer to the other tank. A biocide can also be added to the floc where the desirable microorganism has been selectively bred to have obtained resistance to the biocide or has been genetically modified to provide resistance to the biocide. High or low pressure can further be used to selectively destroy bacteria in the seed floc where the algae or otherwise desirable microorganism is able to withstand the pressure and/or the pressure change.

When the desirable microorganism is a motile, an environmental signal, such as light, may be used in the reaction chamber or in a separate chamber to separate the target microorganism from competing microorganisms prior to seeding the other batch reactor chamber. In this case, the effluent that is discharged can be removed off of the bottom of the batch reactor, unlike in most current sequencing batch reactor designs that decant the effluent off of the top of the reactor. In this design, the tank can be drained such that the motile species are able to swim fast enough towards the light source to be able to remain in the final biomass destined as a seed for the other reactor.

A light source can also be used to drive a desired motile microorganism to the bottom of the tank. Alternatively, if the desirable species is larger it can also settle to the bottom zone of the tank at a faster rate than smaller prokaryotic microorganisms. In these situations, the effluent may be decanted off of the top of the tank. Alternatively, the desired microorganism (e.g., algae) may be removed from the tank and transferred to the other batch reactor. Then, the pH may be raised from a lower level that was previously encouraging growth of this algae (pH<7) to a pH level that encourages bacterial growth (pH 7-9). Aeration may be stopped in this step in order to encourage denitrification and consumption of remaining carbon source in the tank. A control system with sensors may determine when to switch from “algae mode” to “denitrification mode” in each reactor by using optimization algorithms. An additional carbon source can also be added from an external tank during the denitrification step if it is determined that carbon source is the limiting reagent in driving the denitrification reaction.

In some embodiments, phosphorus may be added to the solution as a method of reducing the pH, while also adding phosphorus to the solution. The benefit to adding phosphorus to the solution is to promote microbial growth if it is known that phosphorus is the limiting reagent to the biological reaction that is being promoted. For example, a system that is connected to a programmable logic controller may detect that there is additional BOD and ammonia in the system that the user desires to be separated in the system through the uptake into the heterotrophic algae microorganism, but there is an insufficient quantity of phosphorus for the algae to grow at the desired and predicted rate. Phosphoric acid may be added to simultaneously lower the pH while also increasing the available phosphorus to the system.

A sequencing batch reactor (SBR) can be used that manipulates pH and other algae/bacterial separation techniques to reduce levels of BOD and total nitrogen. A target application can include a wastewater stream with high levels of BOD and total nitrogen, although the present technology can be used in other applications. In the SBR process, two reaction chambers alternate between a heterotrophic removal of BOD using algae and a bacteria-driven denitrification reaction. The tank is first operated at a pH below 7 in an algae-dominated environment in order to reduce the BOD levels. The algae is then separated and removed by using settling, membranes, light, or one of the other techniques described herein. Once removed, a portion of the algae is dewatered and removed from the SBR system and a portion may be used to seed the other reactor tank. The system is then allowed to go to anaerobic, with the pH level being increased to the optimal level for denitrification (pH 7-9). Some bacteria seed may be added from the other tank at this time. The bacteria seed may be separated using membranes, clarifiers, or other techniques to concentrate the bacterial seed. With high populations of the correct bacterial strains present and the optimal pH level, denitrification can occurs rapidly. Once the appropriate level of total nitrogen is achieved, the tank is emptied. Some bacterial seed may be sent to the other SBR tank at this point. The remaining effluent can be disposed of, with optional disinfection taking place prior to disposal to a waterbody or sewage system. The tank can be refilled and reseeded with heterotrophic algae at this point and the reaction continues as described.

The general SBR process can be modified in several ways. For example, acetic acid or another organic acid can be delivered to the system to reduce the pH while simultaneously providing a carbon source to the system. If the biological oxygen demand is the limiting reagent to the biological reaction in the heterotrophic algae, then addition of an organic acid can simultaneously achieve both goals. Carbon dioxide can also be added to the system as a method of lowering the pH level. For example, a flue gas from a coal power plant can be bubbled into the system in a controlled manner to maintain an optimal pH level, where the carbon dioxide forms carbonic acid in the wastewater media. A recycle stream can be returned from the effluent stream that contains a concentration of an acid in order to reduce the amount of acid that needs to be added to the system; i.e., the acid can be recycled back into the system.

The algae can be allowed to settle naturally or faster settling may be induced through the use of chemical flocculants that can include iron oxide, alum, and polymer flocculants. The pH can also be reduced below 6 or raised above 8 to enhance or reduce the presence of biological flocculants, or to prevent the growth of biofilms on membranes or other structures that are present within the bioreactor.

The heterotrophic algae wastewater system can be controlled by an automated control system that includes a logic controller that is connected to external sensors and automated dosing tanks. The automated sensors may include pH sensors, BOD sensors, turbidity sensors, temperature sensors, chlorine sensors, ammonia sensors, and others. The dosing tanks can include acids or bases that are intended to affect the pH, chlorine, ammonia, phosphoric acid, oxygen, light, or other chemicals that are intended to affect BOD, nitrogen, phosphorus, or pH concentrations in the system. A photometer may be used in combination with these sensors to project the level of photosynthesis that is expected to occur. Accordingly, a reaction model and algorithms used to govern the addition of such chemicals can be expanded to include the effects of light and photosynthesis on the overall reaction rates, including microorganism growth and decreases in BOD, nitrogen, and phosphorous levels. The inclusion of light, temperature, BOD, and nitrogen and phosphorous sensors in a control system is a unique aspect of the present technology.

The control system can receive various inputs, process these inputs, and provide various outputs. Inputs can be received from other system components, sensor, or sensor arrays. Examples of inputs into the control system include: dissolved oxygen amount in a liquid stream, such as wastewater; flow rate of air or oxygen bubbled into a wastewater or media; BOD; nitrogen compound levels, including ammonia, nitrates, nitrites; phosphorous and phosphorous compound levels; pH; light intensity; temperature; flow rate; and mixing rate. Such inputs can be provided to material prior to entry into the bioreactor (e.g., wastewater influent), material within the bioreactor (e.g., wastewater growth media containing the microbes), and/or material processed by the bioreactor (e.g., wastewater effluent). The various inputs can be processed by the control system to effect certain outputs, including controlling actuation of other portions of the wastewater treatment system. Examples of outputs from the control system include: addition of acid or base to change pH, where pH can be changed in a wastewater influent or the bioreactor; addition of a carbon source suitable for one or more heterotrophic microorganisms in the bioreactor; addition of one or more limiting nutrients, including phosphorous and nitrogen and compounds thereof; addition of ammonia; modification of retention time in the bioreactor; and changes in aeration, including increasing/decreasing stir rate or agitation, bubbling, or amount of air or oxygen fed into the system.

The control system can operate locally or the information can be conducted over a network, with the central logic model conducted on a central server to control multiple algae production systems from a single location. The benefits of this architecture include faster computing time, central database management, and faster updates to the model. Likewise, remote sensors can stream data describing the pH, temperature, and performance of the system. A single control system location can make it easier to manage and analyze large datasets to develop a set of optimized algorithms based upon Kalman filtering or other techniques in order provide for optimized operations. Algorithms to predict the ambient weather can also be included that can take account of future effects upon the flow volumes and temperature of the wastewater solution, such that the system can predict and self-adjust to optimize biomass production, BOD removal, and to prevent system crashes.

In various embodiments, a fraction of the incoming wastewater can be diverted to one or more seed tanks in order to grow the target microorganism under a different growth regime prior to adding the microorganism into the main treatment tanks. As an example, for a wastewater flow of 2 million gallons per day, 100,000 gallons per day can be diverted to one or more seed tanks that have a hydraulic retention time of 5 days. Environmental conditions in the seed tanks can be altered, including increasing nutrients or essential metals, vitamins, etc., the pH can be altered and/or there can be increased sunlight or artificial lighting compared to the primary treatment tanks in order to favor the production of the target treatment microorganism. At a minimum, the hydraulic retention time in the seed tanks can be longer than the hydraulic retention time in the main treatment tanks. The water flow exiting the seed tanks has a higher concentration of the target treatment microorganism than when it entered the seed tanks and this mixture of water flow and treatment microorganism is added to the main treatment tanks.

In certain embodiments, biomass harvested from the bioreactor can be reduced to a solids level of between 5% and 35% using standard solids separation technologies (e.g. filter press, centrifuge, clarifier, etc.) and then further dried to a moisture content of less than 10% using a standard biomass drying technology, such as one or more drum driers, spray driers, sludge driers, and blender driers. The dried biomass can then be ground to a desired particle size (e.g., 500 micron).

The biomass exiting the system and the wastewater can be further treated in various ways. The biomass exiting the harvesting system can be mixed with a metal solution (e.g. zinc) to form a metal complex. The biomass cells can also be lysed prior to complexing with the metal. The proteins in the lysed biomass can also be hydrolyzed prior to complexing with the metal in order to form a metal proteinate complex. Wastewater influent can be sterilized or pasteurized in order to create a microorganism-free influent stream or a substantially microorganism-free influent stream. This can be beneficial for generating a monoculture of a eukaryotic treatment microorganism by preventing the addition of competing microorganisms. The wastewater can also be pre-concentrated using membrane technologies in order to have a higher strength wastewater and reduce the total volume of wastewater subjected to the present systems and methods. For example, wastewater including a sugar waste stream can have an initial BOD concentration of 1000 mg/L and a flow of 1 million gallons per day, which could then be concentrated into a smaller volume of approximately 50,000 gallons per day and a BOD level of 20,000 mg/L.

Another issue in wastewater treatment is the removal of hydrocarbons. The present technology can further include treating the wastewater with an anaerobic digestion process to reduce hydrocarbons. There are typically four stages in such an anaerobic digestion process: hydrolysis, acidogenesis, acetogenesis, and methanogenesis. In hydroloysis, carbohydrates, fats and proteins are broken down into more simple sugar, fatty acids, and amino acid molecules. In acidogenesis, resulting products are broken down into carbonic acids, alcohols, hydrogen, carbon dioxide and ammonia. In acetogenesis the products from acidogenesis are converted into hydrogen, acetic acid, and carbon dioxide. Finally, the products from acetogenesis are converted into methane and carbon dioxide in the final biologically-driven conversion step of methanogenesis. Such anaerobic digestion processes can include of batch or continuous process configurations, mesophilic or thermophilic temperature conditions, high or low solids compositions, and single or multistage process design configurations. The methane generated in this reaction can be used to generate electricity and this process has recently grown in popularity for that reason. The anaerobic digestion process typically employs heterotrophic prokaryotes (e.g., bacteria) and can be included on the front end or the back end of the present systems and methods employing an eukaryotic microorganism.

Aspects of the present technology can be incorporated into the wastewater treatment methods and systems described in U.S. Pat. No. 8,308,944 to Geoff Horst, the entire disclosure of which is incorporated herein by reference.

### EXAMPLES

With reference to FIG. 1, a process flow diagram of a pH controlled bioreactor system 100 is shown, where optional portions are depicted by stippled lines. In the system 100, a bioreactor 105 is fed a wastewater influent 110. One or both of the bioreactor 105 and the wastewater influent 110 includes a heterotrophic eukaryote, such as an algae of the genus Euglena. The wastewater influent 110 can serve as all or a portion of the growth media in the bioreactor 105; for example, the bioreactor 105 can already include a growth media and/or growth media components that are supplemented with the wastewater influent 110. The bioreactor 105 has an aeration or oxygenation system 115, which can include one or more bubblers, mixers, sprayers for the addition of air or oxygen, and can also include the use of a bioreactor 105 having a shallow configuration that provides an increased surface area between the growth media and air. A pH controller 120 senses a pH of the bioreactor 105 and controls the addition of acid 125 and the addition of base 130 in order to change the pH of the growth media in the bioreactor 105 to a desired value. For example, the pH can be changed up to one or more pH units and the pH can be changed multiple times or set to cycle at a predetermined interval or upon biological activity in the growth media altering the pH to a particular threshold. After a defined time or condition is met, an effluent 135 is removed from the bioreactor 105. The defined time can be based on a growth curve of the heterotrophic eukaryote and/or based upon a measurement of the growth media, including a measurement of BOD, nitrogen, and/or phosphorous. The effluent 135 can include all or a portion of the bioreactor 105 contents.

The system 100 can include various additional components as shown in FIG. 1. For example, the wastewater influent 110 can be processed by anaerobic digestion using a heterotrophic prokaryote in an acidogenic/acetogenic anaerobic reactor 140 and then sent to the bioreactor 105. In this way, certain hydrocarbons can be digested in conditions optimized for the heterotrophic prokaryote in the anaerobic reactor 140. Remaining BOD levels, including nitrogen and phosphorous, are then treated in the bioreactor 105 with the heterotrophic eukaryote to further reduce BOD and sequester nitrogen and phosphorous within the heterotrophic eukaryote biomass. A seed tank 145 can provide a source of heterotrophic eukaryote to the bioreactor 105 and can provide an environment optimized for the heterotrophic eukaryote. For example, a light source 150 can be used to promote photosynthetic growth of an algae, where limited carbon source(s) suppress the growth of heterotrophic prokaryotes. The heterotrophic eukaryote in the seed tank 145 can also be acclimated to the wastewater influent 145 so the metabolism of the heterotrophic eukaryote is already suited for digesting the wastewater influent 145 when the heterotrophic eukaryote is seeded into the bioreactor 105. Another light source 155 can be used in conjunction with the bioreactor 105 to aid in enriching or separating a heterotrophic eukaryote that is also capable of photosynthetic growth and/or where motility of the microorganism is responsive to light; e.g., algae of the genus Euglena. Various supplemental nutrients 160 can be provided to the bioreactor 105 as warranted. For example, growth limiting nutrients, such as nitrogen, phosphorous, or various trace metals, can be added. The effluent 135 of the bioreactor 105 can be further processed by a harvesting system 165 that can capture the resulting biomass and separate solids from the liquid portion of the effluent 135. In certain cases, the solid portion or at least a partially dewatered portion from the harvesting system 165 can be dried in a biomass drying system 170. A dried or partially dried biomass component from the drying system 170 can be complexed with a metal using a metal complexing process 175 and/or material from the harvesting system 165 can be directed to the metal complexing process 175.

With reference to FIG. 2, a sequencing batch reactor (SBR) process 200 is shown for use as a bioreactor in the present technology, such as the bioreactor 105 shown in FIG. 1. The SBR process 200 includes at least two reactors 205 having a common inlet, which can be switched between each reactor 205. The SBR process 200 is diagramed in FIG. 2 using only one reactor 205, where participation of the additional reactor(s) 205 will be understood from the following description. The reactors 205 are conFIG.d as a flow-through system, with a fill or wastewater influent entering at one end and treated effluent exiting out the other. While one reactor 205 is in a settle or decant mode the other reactor 205 is aerating and filling. This allows treatment of the wastewater stream in defined aliquots, providing sequential charging of reactors 205 and with continual pulsed draws taken from the wastewater stream. The fill entering the reactor 205 can be run through an aerator and/or mixer as the reactor 205 is charged with wastewater. The treatment stages shown in the diagrammed process 200 in FIG. 2 include a fill stage 210, a react stage 215, a settle stage 220, and a draw stage 225. During the fill stage 210, a fill of wastewater is provided to the reactor 205. Mixing can be provided by mechanical means without aeration in the anoxic portion 230 of the react stage 215. Aeration of the mixed wastewater is then performed during the aerobic portion 235 of the react stage 215 using a various means, such as a fixed or floating mechanical pump or by transferring air into bubblers or diffusers. No aeration or mixing is provided in the settle stage 220, where suspended solids begin settle out of the wastewater by gravity. The draw stage 225 includes removing the treated effluent, clarified during the settle stage 220, from an upper portion of the reactor 205. Solids, sludge, and biomass can be removed from a lower portion of the reactor 205. For example, the number of reactors 205 in the SBR process can be increased so that when one reactor 205 is completing the fill stage 210 another reactor 205 is completing the draw stage 225, so the wastewater stream can then be fed to the reactor 205 leaving the draw stage 225. Continuous charges of wastewater fill can therefore be treated by the process 200. Additional nutrients may be added to one or more of the reactors 205 to supplement any growth limiting effects experienced by the eukaryotic microorganism, as is described herein.

With reference to FIG. 3, a process flow diagram of membrane separation 300 of a eukaryotic microorganism (e.g., algae) from a bioreactor 305 is shown. The bioreactor 305 can be the bioreactor 105 shown in FIG. 1 or one of the reactors 205 used in the SBR process of FIG. 2. A membrane module 310 is used to remove effluent from the reactor 305 where the membrane module 310 includes a pore size that prevents passage of eukaryotic cells (e.g., algae), while liquid and smaller microorganisms (e.g., prokaryotic cells) can pass through and be removed from the reactor 305. As shown, the membrane module 310 is located inside the reactor 305, but could be positioned elsewhere with the caveat that the eukaryotic cells retained by the membrane module 310 are used to seed the original bioreactor 305 and/or used to seed another such bioreactor 305. The eukaryotic cells and any other material or solids retained by the membrane module 310 can be further processed for biomass separation, drying, and storage, as shown in the process flow diagram.

With reference to FIG. 4, a process flow diagram is shown for a light-based selection process 400. The process 400 employs a bioreactor 405 and a light source 410 to separate photosensitive and motile eukaryotic microorganisms from a remainder of a treated wastewater growth media including undesirable microbes. For example, a strain of algae (e.g., Euglena) that is motile and attracted to light will migrate within the growth media towards the location of the light source 410 with respect to the bioreactor 405. As shown, the light source 410 is located at top of the bioreactor 405, but other locations are possible. Following migration of the photosensitive and motile eukaryotic microorganisms towards the light, a lower portion of the growth media including treated wastewater can be removed as treated effluent. The treated effluent can be discharged from the bottom of the bioreactor 405, which is unlike other methods that decant a treated effluent from of the top of the bioreactor 405. In the light-based selection process 400, the bioreactor 405 can be drained at rate such that the photosensitive and motile eukaryotic microorganisms are able to migrate fast enough towards the light source 410 and remain in the reactor 405. Alternatively, once the treated effluent is removed, the remaining photosensitive and motile eukaryotic microorganisms can be removed from the reactor 405 and used to seed another bioreactor.

With reference to FIG. 5, a process flow diagram is shown for another light-based selection process 500. In contrast to the preceding process shown in FIG. 4, photosensitive and motile eukaryotic microorganisms in a bioreactor 505 are separated from a remainder of a treated wastewater growth media including undesirable microbes by repelling the photosensitive and motile eukaryotic microorganisms using a strong light source 510. The strong light source 510 can be used to drive the photosensitive and motile eukaryotic microorganisms to the bottom of the bioreactor 505 so that a treated effluent can be decanted off of the top of the bioreactor 505. The photosensitive and motile eukaryotic microorganisms (e.g., algae) can also be removed from the bottom of the bioreactor 505 and transferred to seed another bioreactor and/or subjected to a solid/liquid separation process.

With reference to FIG. 6, a process flow diagram is shown for an alternating heterotrophic algae and denitrification process 600 using a bioreactor 605. The process 600 can employ a sequencing batch reactor process with multiple reactors 605, such as described with respect to FIG. 2, where the reactors 605 are used to treat wastewater having high BOD and high total nitrogen (TN). A bioreactor 605 is filled or refilled at 610 with untreated wastewater and seeded with a heterotrophic eukaryote (e.g., algae) and heterotrophic prokaryote (e.g., nitrifying bacteria). The mixed wastewater growth media, eukaryote, and prokaryote are grown aerobically at 615 at a pH less than 7. After some time or obtaining some desired change in the wastewater growth media, the aeration is discontinued and the eukaryotic microorganisms and prokaryotic microorganisms are separated at 620. One or more of the various separation methods described herein can be employed at 620, such as the various light-based selection processes detailed in FIG. 4 and FIG. 5. The pH is maintained at less than 7. Once the eukaryotic microorganism is separated, it is removed and used to seed another bioreactor 605, where multiple reactors 605 can be used in the aforementioned sequencing batch reactor process. The prokaryotic microorganism remains and conditions are adjusted for denitrification at 625, where the pH is from 7-9 and aeration is stopped. Additional prokaryote (e.g., nitrifying bacteria) can be added at 625. After some time or obtaining some desired change in the wastewater growth media (e.g., a desired change in TN is observed), the treated wastewater is removed from bioreactor 605 and the bioreactor 605 is employed again at 610.

With reference to FIG. 7, a process flow diagram is shown for a low-pH wastewater treatment process 700. Any number of industrial processes, such as the industrial process at 705, can produce a wastewater stream 710 having various BOD, nitrogen, and phosphorous levels. The wastewater stream 710 can also include other materials or compounds for bioremediation, such as hydrocarbons, fatty acids, etc., as described herein. It can be desirable to allow the wastewater stream to settle, where the primary settling at 715 can separate a portion of solids from the wastewater. The settled wastewater is then decanted or transferred to a bioreactor, including one or more of the various bioreactors and bioreactor processes described herein, and a heterotrophic eukaryote (e.g., algae) is aerobically grown in the wastewater at 720. Here, acid is added as necessary to bring the pH to less than 6. Air or oxygen can be added as necessary to promote aerobic growth of the eukaryotic microorganism. The low pH can be maintained to suppress bacterial growth and/or the pH can cycled between one or more pH units to suppress prokaryotic microorganism growth. After a given time or reaching a desired condition, such as a certain BOD, nitrogen, or phosphorous level, biomass is separated at 725 from a portion of the liquid in the treated wastewater. The treated wastewater can be recycled to the industrial process 705 at this point. The water recycling can include further steps depending on the nature of the industrial process and water needs. For example, the water recycling can include pasteurization, chlorination, filtering, or subsequent bioreactor treatments. The biomass can be harvested as shown at 730 and used for reseeding one or more bioreactors used at 720, for example, or metabolic products of the eukaryotic microorganism can be harvested; e.g., carbohydrates, fatty acids, metals or metal complexes, etc.

With reference to FIG. 8, a process flow diagram is shown for another low-pH wastewater treatment process 800. Again, an industrial process 805 outputs a wastewater stream at 810. The wastewater stream can be allowed to settle at 815 to separate a portion of solids from the wastewater. The settled wastewater is then decanted or transferred to a bioreactor, including one or more of the various bioreactors and bioreactor processes described herein, where conditions are favorable for heterotrophic prokaryotic growth. Anaerobic digestion then proceeds at 820. Biogas evolving from the anaerobic digestion 820 can be collected and combusted as shown at 825, where combustion can be coupled with electricity generation as shown at 830, for example. Alternatively, the combustion at 825 can be coupled with other industrial processes, including use in the industrial process at 805. Following the anaerobic digestion, the digested wastewater stream is transferred to another bioreactor for aerobic digestion using a heterotrophic eukaryote (e.g., algae) at a low pH (e.g, less than 6). Carbon dioxide resulting from the combustion of biogas at 825 can be added to the aerobic digestion bioreactor to lower the pH, where the carbon dioxide forms carbonic acid in the wastewater growth media. After a given time or reaching a desired condition, such as a certain BOD, nitrogen, or phosphorous level, biomass is separated at 840 from a portion of the liquid in the treated wastewater. The treated wastewater can be recycled to the industrial process 805 at this point, where the recycling can include further process steps as described herein. The biomass can be harvested as shown at 845 and used for reseeding one or more bioreactors used at 835, for example, or metabolic products of the eukaryotic microorganism can be harvested; e.g., carbohydrates, fatty acids, metals or metal complexes, etc.

With reference to FIG. 9, a process flow diagram is shown for yet another low-pH wastewater treatment process 900. A wastewater stream of 2 million gallons per day (MGD) having a BOD of 2200 mg/l, shown at 905, is split into a first stream of 0.1 MGD and a second stream of 1.9 MGD. The first stream is fed to heterotrophic eukaryotic microorganism growth bioreactors to acclimate the microorganism to the wastewater and to provide an inoculum for seeding primary treatment bioreactors. The second stream is fed to the primary treatment bioreactors shown at 915. Here, 5 million gallons of wastewater is treated by aerobic digestion with the heterotrophic eukaryotic microorganism. The primary treatment bioreactors at 915 can be maintained at an acidic pH and/or the pH can be cycled within one or more pH units to favor eukaryotic microorganism growth and suppress prokaryotic microorganism growth. After a given time or reaching a desired condition, such as a certain BOD, nitrogen, or phosphorous level, biomass is separated from a portion of the liquid in the treated wastewater at 920. A filter press is shown at 920 to illustrate one means for removing the eukaryotic microorganisms and reducing the amount of solids in the treatment effluent. The 2 MGD of filter press effluent, now having a BOD value of less than 100 mg/l, can then be discharged or recycled for use an an industrial process (e.g., used for cooling).

With reference to FIGS. 10-13, results of four bench-scale experiments (T1, T2, T3, and T4) are graphically depicted that demonstrate the BOD removal efficiency of the present low-pH biological treatment processes. An inoculum of Euglena and other heterotrophic protists/algae (5 or 15 ml) was added to 95 or 85 ml (respectively) of untreated brewery wastewater. The pH was lowered to 5 and samples were taken every 24 hrs. BOD analysis was performed on the supernatant of centrifuged samples using standard methods (FIG. 10). Chemical oxygen demand (COD) analysis was performed on the supernatant of centrifuged samples using HACH brand COD analysis tubes and protocols (FIG. 11). Total nitrogen analysis was performed on the supernatant of centrifuged samples using HACH brand total nitrogen protocols (FIG. 12). Data values obtained from the four bench-scale experiments, showing chemical oxygen demand (COD), total nitrogen (TN), total suspended solids (TSS), and biological oxygen demand (BOD) at days 0, 1, 3, and 8 of the four cultures (T1, T2, T3, and T4) is presented in FIG. 13.

It should be understood that, within the scope of the present disclosure, the pH modulation to affect the biological community can be either upwards or downwards. For example, although a lowering of the pH may be performed as described hereinabove, skilled artisans understand that upward pH diversions using a base may also be employed, as desired. Likewise, it should be appreciated that the pH diversion, even if downward, may not end in an “acidic” range (i.e. below pH 7) in all cases.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of treating a wastewater that favors viability of a eukaryotic microorganism and disfavors viability of a prokaryotic microorganism, the method comprising:
adjusting the pH of the wastewater between a first pH value and a second pH value, the wastewater including the eukaryotic microorganism.

2. The method of claim 1, wherein the pH of the wastewater is adjusted between the first pH value and the second pH value in less than about four hours.

3. The method of claim 1, wherein the adjusting step includes cycling the pH between the first pH value and the second pH value a plurality of times.

4. The method of claim 3, wherein each cycle is performed in less than about four hours.

5. The method of claim 1, wherein the eukaryotic microorganism includes a heterotrophic eukaryotic microorganism.

6. The method of claim 1, wherein the eukaryotic microorganism includes a photosynthetic and motile eukaryotic microorganism.

7. The method of claim 1, wherein the eukaryotic microorganism includes an algae.

8. The method of claim 1, wherein the eukaryotic microorganism is of the genus Euglena.

9. The method of claim 1, wherein the first pH value and the second pH value are separated by at least about one pH unit.

10. The method of claim 1, wherein the first pH value and the second pH value are separated by at least about two pH units.

11. The method of claim 1, wherein the first pH value and the second pH value are separated by at least about four pH units.

12. The method of claim 1, wherein one of the first pH value and the second pH value is an acidic pH value of less than about six.

13. The method of claim 1, wherein the adjusting step is preceded by anaerobic digestion of the wastewater with the prokaryotic microorganism.

14. The method of claim 13, wherein the prokaryotic microorganism includes a nitrifying bacteria.

15. The method of claim 13, wherein the anaerobic digestion includes a hydrolysis stage, an acidogenesis stage, an acetogenesis stage, and a methanogenesis stage.

16. The method of claim 1, wherein one of the first pH value and the second pH value is an acidic pH value, and further comprising combusting a biogas collected from the anaerobic digestion and using carbon dioxide from the combusting step in the adjusting step, the carbon dioxide forming carbonic acid in the wastewater to obtain the acidic pH value.

17. The method of claim 1, further comprising aerating the wastewater including the eukaryotic microorganism.

18. The method of claim 1, further comprising illuminating the wastewater including the eukaryotic microorganism with a light source.

19. The method of claim 1, further comprising performing a solid/liquid separation process to remove solids from the wastewater.

20. The method of claim 1, wherein the eukaryotic microorganism was acclimated to the wastewater prior to the adjusting step.

21. The method of claim 1, further comprising supplying a growth limiting nutrient to the wastewater including the eukaryotic microorganism.

22. The method of claim 1, wherein the wastewater including the eukaryotic microorganism is processed using a sequencing batch reactor process including a plurality of bioreactors, and the adjusting step is performed during an aerobic portion of a react stage of the sequencing batch reactor process.

23. The method of claim 1, further comprising removing an effluent from the wastewater including the eukaryotic microorganism after the adjusting step, wherein removing the effluent includes passing the wastewater through a membrane module having a pore size that allows the effluent to pass therethrough and the eukaryotic microorganism to be retained.

24. The method of claim 1, further comprising illuminating the wastewater including the eukaryotic microorganism with a light source to form a first wastewater portion and a second wastewater portion, the first wastewater portion having a higher concentration of the eukaryotic microorganism than the second wastewater portion.

25. The method of claim 24, further comprising separating the first wastewater portion from the second waste water portion.

26. The method of claim 25, further comprising combining the first wastewater portion having a higher concentration of the eukaryotic microorganism with a new amount of wastewater.

27. The method of claim 1, wherein the wastewater has a first biological oxygen demand value prior to the adjusting step and a second biological oxygen demand value after the adjusting step, the second biological oxygen demand value being at least one order of magnitude less than the first biological oxygen demand value.

28. A method of treating a wastewater that favors viability of a eukaryotic microorganism and disfavors viability of a prokaryotic microorganism, the method comprising:
cycling the pH of the wastewater between a first pH value and a second pH value a plurality of times, the wastewater including the eukaryotic microorganism, and the first pH value and the second pH value are separated by at least two pH units.

29. A method of treating a wastewater that favors viability of a eukaryotic microorganism and disfavors viability of a prokaryotic microorganism, the method comprising:
anaerobically digesting the wastewater with the prokaryotic microorganism; and
cycling the pH of the wastewater between a first pH value and a second pH value a plurality of times, the wastewater including the eukaryotic microorganism, and the first pH value and the second pH value are separated by at least one pH unit.
